(19) United States
(12) Patent Application Publication
(10) Pub. No.: US 2024/0340066 A1
(43) Pub. Date: Oct. 10, 2024

(54) BEAM MANAGEMENT OF SL FR2

(71) Applicant: MediaTek Singapore Pte. Ltd., Singapore (SG)

(72) Inventors: Chenmeng Li, Beijing (CN); Jun-Qiang Cheng, Beijing (CN); Tao Chen, Beijing (CN); Ming-Yuan Cheng, Hsinchu (TW)

(21) Appl. No.: 18/623,166

(22) Filed: Apr. 1, 2024

(30) Foreign Application Priority Data
Apr. 7, 2023 (WO) PCT/CN2023/087068
Mar. 27, 2024 (CN) 202410361393.2

(51) Int. Cl. H04B 7/06; H04L 1/1607; H04W 72/40

(52) U.S. Cl. CPC H04B 7/06952; H04L 1/1607; H04W 72/40

(57) ABSTRACT

In an aspect of the disclosure, a method, a computer-readable medium, and an apparatus are provided. The apparatus may be a first UE. The first UE transmits a plurality of reference signals (RSs) using a plurality of transmission beams on a sidelink. The first UE receives, from a second UE, a beam report carried on a Physical Sidelink Feedback Channel (PSFCH). The beam report indicates beam qualities generated by the second UE based on measurements of the plurality of RSs. The first UE selects a transmission beam and a reception beam based on the beam qualities. The first UE establishes a sidelink communication with the second UE using the selected transmission beam and the selected reception beam on the sidelink.

### CROSS-REFERENCE TO RELATED APPLICATION(S)

This application claims the benefits of PCT Application Number PCT/CN2023/087068, entitled “METHODS FOR LBT FAILURE INDICATION OF SL-U” and filed on Apr. 7, 2023, which is expressly incorporated by reference herein in its entirety.

### BACKGROUND

### Field

The present disclosure relates generally to communication systems, and more particularly, to techniques of beam management of a sidelink in frequency range 2 (FR2).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first UE. The first UE transmits a plurality of reference signals (RSs) using a plurality of transmission beams on a sidelink. The first UE receives, from a second UE, a beam report carried on a Physical Sidelink Feedback Channel (PSFCH). The beam report indicates beam qualities generated by the second UE based on measurements of the plurality of RSs. The first UE selects a transmission beam and a reception beam based on the beam qualities. The first UE establishes a sidelink communication with the second UE using the selected transmission beam and the selected reception beam on the sidelink.

In another aspect of the disclosure, a method, a computer-readable medium, and an apparatus are provided. The apparatus may be a first UE. The first UE configures a Channel State Information Reference Signal (CSI-RS) resource mapping for beam management before or during link establishment with a second UE on a sidelink. The first UE transmits, to the second UE, an indication indicating at least one of a time domain location and a frequency domain location of a CSI-RS resource based on the CSI-RS resource mapping.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating sidelink (SL) communications between UEs.

FIG. 8 is a diagram illustrating an initial beam paring procedure between a transmitting (Tx) UE and a receiving (Rx) UE on a sidelink.

FIG. 9 is a diagram illustrating a beam burst pattern.

FIG. 10 is a diagram illustrating a beam reporting.

FIG. 11 is a flow chart of a method (process) for establishing a sidelink communication between user equipments (UEs).

FIG. 12 is a flow chart of a method (process) for beam management on a sidelink.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

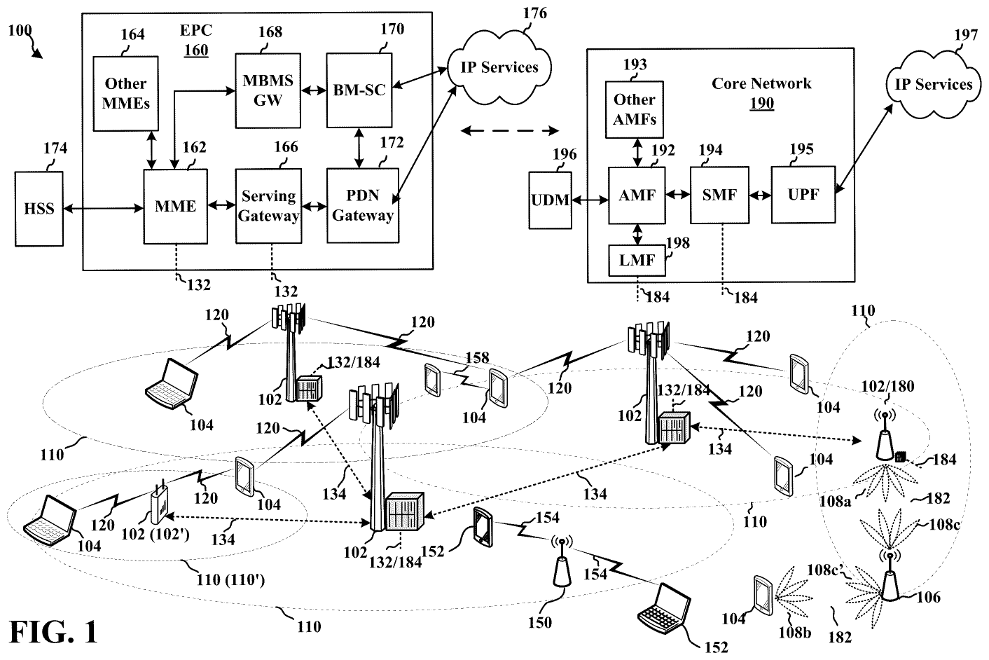

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

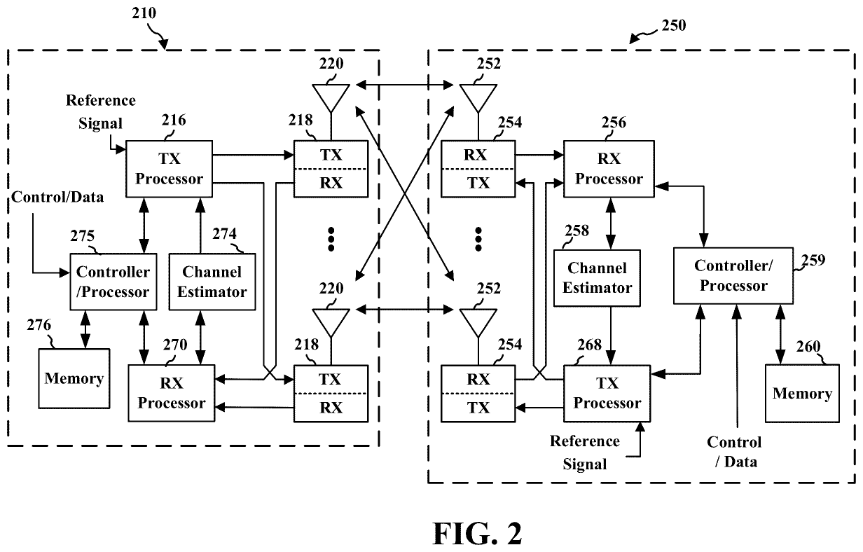

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

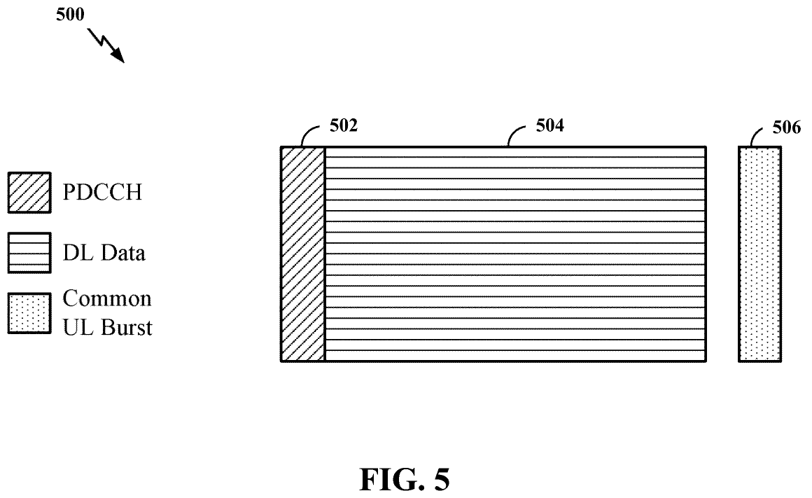

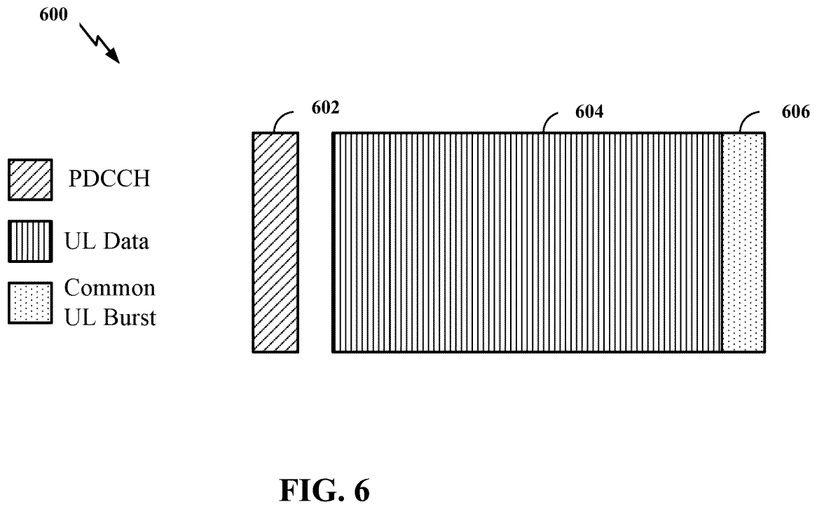

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

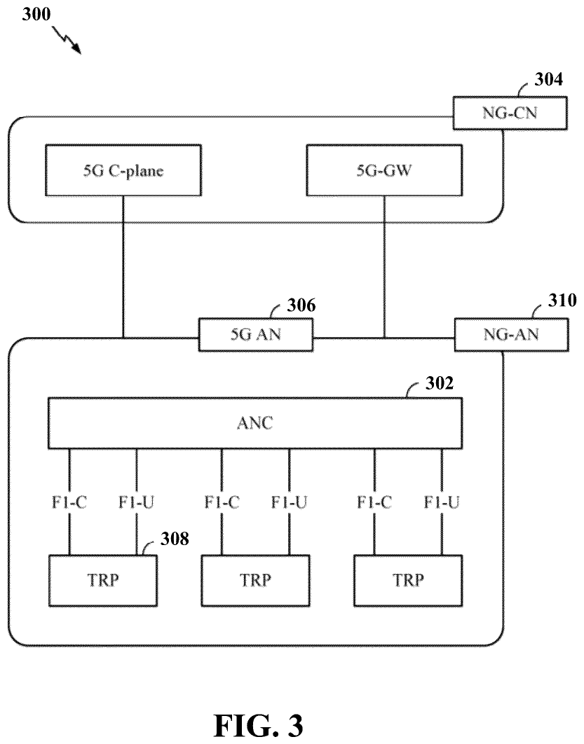

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

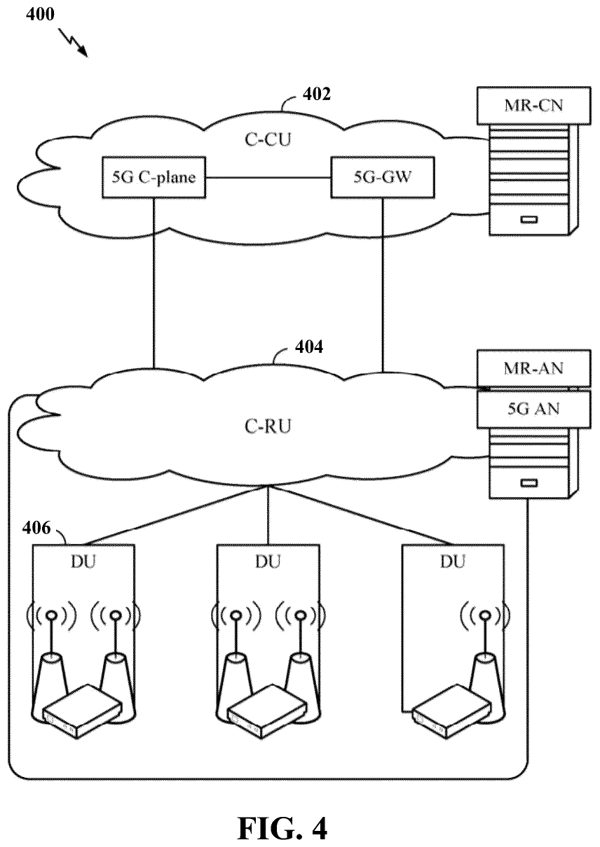

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

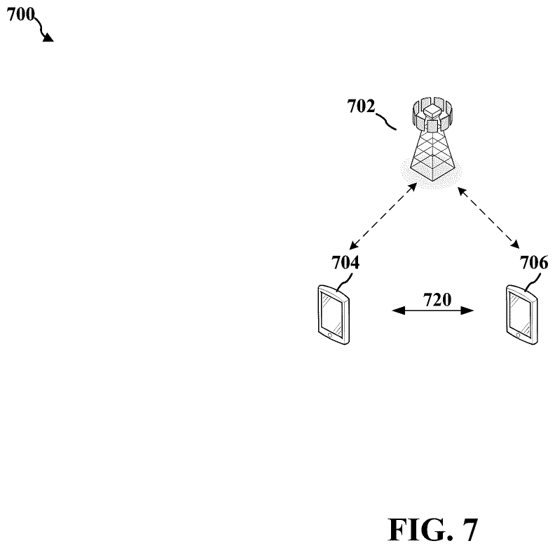

FIG. 7 is a diagram illustrating sidelink (SL) communications between UEs. In this example, a UE 704 and a UE 706 may establish a sidelink 720. In certain configurations, the establishment of the sidelink 720 and the communications on the sidelink 720 may be assisted by a base station 702. Each of the UE 704 and the UE 706 may have a structure similar to that of the UE 250.

In NR sidelink (SL), the concept of beam has not been discussed for FR2. In the legacy NR SL, the S-SSB is only for synchronization purpose and is only transmitted by a sync reference UE. Furthermore, only aperiodic channel state information (CSI) request is allowed in the legacy NR SL. These limitations necessitate the design of a reliable beam management method for SL in FR2, which includes initial beam pairing (IBP), beam maintenance (BM), and beam failure recovery (BFR).

Currently, SL is only defined for FR1, where a UE has only one omnidirectional beam. However, in FR2, a UE has multiple beams that cannot be simultaneously transmitted. Therefore, when establishing the sidelink 720 between the UE 704 and the UE 706, a new beam management procedure needs to be designed for SL in FR2. This procedure may involve the base station 702 assisting in the establishment and communications on the sidelink 720.

The beam management procedure for SL in FR2 requires the design of new signals and reporting schemes. The IBP procedure aims to find the best or an adequate beam pair for the UE 704 and the UE 706 before establishing the sidelink 720. This involves the UE 704 transmitting reference signals (RS), such as CSI-RS, DMRS, or SSB, using different beams. The UE 706 then measures the received signal power, such as RSRP, for each beam and selects the best beam pair based on the measurements. The UE 706 reports the selected beam information to the UE 704, allowing both UEs to establish the sidelink 720 using the optimal beam pair.

The link establishment procedure on a sidelink, such as the sidelink 720 between the UE 704 and the UE 706, is similar to the discovery process in LTE. The sidelink communication occurs directly between UEs without necessarily involving a base station or network, such as the base station 702. The UE 704 sends a discovery message or direct communication request message using a Physical Sidelink Control Channel (PSCCH) or Physical Sidelink Shared Channel (PSSCH). Other UEs, such as the UE 706, receive this message and obtain information about the services the UE 704 can provide or requires. If the receiving UE, such as the UE 706, decides to establish a connection with the UE 704, it sends a feedback message, also using PSCCH or PSSCH.

The time and frequency domain resources for these messages may be preconfigured, and the UEs will specifically look for messages in these resources. Synchronization in the time and frequency domains may be achieved through previous communication with base stations, other synchronization reference UEs, or GNSS.

The Initial Beam Pairing (IBP) process involves the transmission of reference signals (RS) such as CSI-RS, DMRS, or modified S-SSB by the UE 704 using different beams. The UE 706 measures these signals, selecting the beam pair that provides the best signal quality, typically based on Received Signal Received Power (RSRP) measurements. This selection is then reported back to the UE 704, allowing both UEs to align their beams optimally for the established sidelink 720.

The IBP process can occur simultaneously with the reception of the discovery message. The reference signals (RS), such as DMRS or CSI-RS, are sent along with the link establishment message in the PSCCH or PSSCH. The receiving UE, having already received the discovery message and knowing the location of the PSCCH and PSSCH, can then detect and measure these reference signals.

The DMRS or CSI-RS are typically contained within the PSCCH and PSSCH in time and frequency domains. The receiving UE, such as the UE 706, detects the link establishment message by first detecting the first Sidelink Control Information (SCI) and then the second SCI. These SCIs may also contain information about the configuration of the reference signals, allowing the receiving UE to further detect the RS within the PSSCH and determine their location.

The link is considered established when the UEs have established an RRC connection. The discovery and beam pairing processes occur before the RRC connection when the UEs have already found the discovery message and know the location of the PSCCH and other channels.

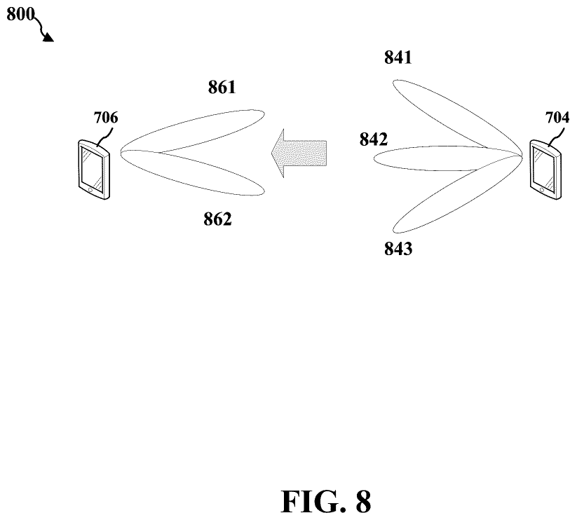

FIG. 8 is a diagram 800 illustrating an initial beam paring procedure between a transmitting (Tx) UE and a receiving (Rx) UE on a sidelink. In this example, the UE 704 is a Tx UE and forms transmission beams 841, 842, and 843 to transmit signals on the sidelink 720. The UE 706 is a Rx UE and forms reception beams 861 and 862 to receive signals on the side link 720.

The Initial Beam Pairing (IBP) procedure aims to find the best or an adequate quality beam pair for the UE 704 and the UE 706 to communicate on the sidelink 720. The UE 704 (Tx UE in this example) transmits reference signals (RSs), such as CSI-RS, DMRS, or SSB, using its different transmission beams 841, 842, and 843. Each beam may have a different beam direction.

The UE 706 (Rx UE in this example) receives the transmitted RSs on different beams and measures their Received Signal Received Power (RSRP) or other relevant metrics. The UE 706 detects the reference signals for each of the UE 704's transmission beams. Based on the RSRP measurements, the UE 706 determines the most suitable transmission beam from the transmission beams 841, 842, 843 of the UE 704. The UE 706 also determines which of its own reception beams 861 or 862 to use for establishing the connection with the UE 704.

After completing the measurements and beam selection, the UE 706 sends a beam report to the UE 704. This report informs the UE 704 about the measurements results, the suitable transmission beam, and/or the suitable reception beam determined by the UE 706.

The UE 704 receives the report and accordingly selects an optimal transmission beam and reception beam pair for communications between the UE 704 and the UE 706 on the side link 720. The base station 702 may assist in the establishment and communications on the sidelink 720, depending on the configuration.

Before link establishment between the UE 704 and the UE 706 for the side link 720, no communication link exists between the UEs. This is similar to an idle state, and the UE 704 and the UE 706 cannot exchange information to configure reference signals for beam management.

During link establishment between the UE 704 and the UE 706 for the side link 720, the UEs are in the process of establishing the communication link between the UEs. The UE 704 and the UE 706 exchange messages, such as discovery messages and feedback messages, using channels PSCCH and PSSCH. These messages can carry information for configuring reference signals, enabling their use for beam management.

Before link establishment between the UE 704 and the UE 706 for the sidelink 720, in a first configuration, the UE 704 may transmit a non-standalone CSI-RS for IBP. A non-standalone CSI-RS is embedded within other physical channels, such as PSCCH and PSSCH. It relies on the configuration of the host channel for its transmission. Accordingly, the UE 704 and the UE 706 both may implement a same method to dynamically determine the configuration of the non-standalone CRI-RS. Further, the UE 704 and the UE 706 may be pre-configured with the configurations of the non-standalone CRI-RS.

In a second configuration, the UE 704 may transmit a standalone CSI-RS for IBP. A standalone CSI-RS has its own dedicated physical channel or is signaled on a dedicated resource, and does not depend on other channels for transmission. The UE 704 and the UE 706 may be preconfigured with the configuration and structure definition of the standalone CRI-RS. The existing NR sidelink does not have a standalone CSI-RS.

In a third configuration, the UE 704 may transmit a modified S-SSB for IBP. This is because the existing S-SSB can only be transmitted by a sync reference UE and not by all UEs.

In a fourth configuration, the UE 704 may transmit PSCCH/PSSCH DMRS for IBP. DMRSs are present within the PSCCH and PSSCH and may be utilized for IBP.

These reference signals can be transmitted by the UE 704 using its transmission beams 841, 842, and 843. The UE 706 can then receive these signals using its reception beams 861 and 862, and perform measurements to determine the optimal beam pair for establishing the sidelink 720.

During link establishment between the UE 704 and the UE 706 for the sidelink 720, the reference signals for IBP can be DMRS and/or CSI-RS within PSCCH and/or PSSCH.

When CSI-RS is used as the reference signal for IBP during link establishment, the first SCI transmitted by the UE 704 can be used to configure the CSI-RS. This can be achieved by introducing a new bit field, denoted as bit field A, within the first SCI. Bit field A carries specific CSI-RS information about the CSI-RS configuration, such as CSI-RS pattern and CSI-RS trigger. CSI-RS pattern indicates the specific pattern of the CSI-RS sequence to be used. CSI-RS trigger specifies the timing or event that triggers the transmission of the CSI-RS.

Further, another one-bit field, denoted as bit field B, can be included in the first SCI to indicate the presence of bit field A. This allows the UE 706 to determine whether CSI-RS configuration information is present and needs to be decoded.

Alternatively, the bit field B indicates the presence of the specific CSI-RS information, and the specific CSI-RS information may be carried in a pre-configured channel/resource or in the channel/resource indicated by bit field A.

The UE 704 can transmit the SCI to the UE 706 during link establishment using the PSCCH. The time and frequency domain location for transmitting the SCI can be pre-configured or determined based on a predefined rule known to both the UE 704 and the UE 706. This allows the UE 706 to monitor the correct time and frequency domain location for receiving the SCI.

Similarly, the time and frequency domain location of the DMRS in PSCCH and PSSCH can be pre-configured or determined based on a predefined rule known to both the UE 704 and the UE 706. This enables both UEs to know where to transmit and receive the DMRS for beam measurements during the IBP procedure.

By utilizing the first SCI to configure and indicate the presence of CSI-RS, and by having predefined rules for the location of SCI and DMRS, the UE 704 and the UE 706 can efficiently perform beam measurements and establish the optimal beam pair for communication on the sidelink 720 during the link establishment phase.

After link establishment between the UE 704 and the UE 706 for the sidelink 720, the UEs are in RRC Connected Mode. In this mode, the reference signals for IBP can be DMRS, CSI-RS, and/or Phase Tracking Reference Signal (PTRS) within PSCCH, PSSCH, and/or Physical Sidelink Feedback Channel (PSFCH).

The CSI-RS information for IBP after link establishment may be configured or pre-configured, for example, through the PC5-RRC interface, instead of being carried and indicated by the SCI. This is because the UEs are already in RRC Connected Mode and have established a communication link.

Alternatively, the pre-configured PSFCH resource carrying CSI-RS/PTRS/DMRS can also be used for initial beam pairing after link establishment. The PSFCH is a physical channel used for transmitting feedback information, such as HARQ-ACK, on the sidelink. By pre-configuring the PSFCH resource, the UE 704 and the UE 706 can use this resource for exchanging beam-related information and performing beam measurements for IBP.

Since the UEs are in RRC Connected Mode after link establishment, there may be no need to design new configuration methods for the reference signals used in IBP. The existing configuration methods can be utilized for configuring the reference signals for IBP after link establishment.

Before and during the link establishment between the UE 704 and the UE 706 for the sidelink 720, in certain configurations, the UE 704 may inform the UE 706 the CSI-RS resource configuration for IBP through mapping.

In a first option, an index or a bit-string is used to represent the combination of time and/or frequency location of CSI-RS resource elements (REs) within a resource block (RB), the starting RB, and the RB quantity in the frequency domain.

For example, a bit-string can be used to indicate the presence or absence of a CSI-RS at each time-frequency location within one or more RBs within one or more OFDM symbols. A ‘1’ at a particular position in the bit-string indicates the presence of a CSI-RS RE, while a ‘0’ indicates the absence of a CSI-RS at that position.

Furthermore, additional bits can be appended to the bit-string to represent the starting RB index and the number of RBs used for CSI-RS transmission in the frequency domain.

Alternatively, an index can be used to represent a predefined combination of CSI-RS RE locations within an RB and the starting RB and number of RBs in the frequency domain. In this case, both the UE 704 and the UE 706 would need to have the same predefined mapping table that associates each index with a specific CSI-RS resource mapping configuration.

In a second option, the time and/or frequency location of CSI-RS within an RB, the starting RB, and the RB quantity in the frequency domain are configured separately.

For instance, the time-domain location of CSI-RS within an RB can be indicated by the symbol indices, while the frequency-domain location can be indicated by the subcarrier indices. The starting RB index and the number of RBs allocated for the CSI-RS transmission can be signaled separately.

Alternatively, the time-domain location of CSI-RS REs within an RB can be represented by a bit-string, similar to the first option. The frequency-domain location of CSI-RS REs within an RB can be represented by another bit-string or by directly indicating the subcarrier indices. The starting RB index and the number of RBs can be specified using a fixed number of bits.

The CSI-RS resource mapping may reuse the NR SL CSI-RS resource mapping method with fixed parameters: nrofPorts={p1}, density=1, and cdm-Type={noCDM}. Other parameters are used to define the CSI-RS location:
firstOFDMSymbolInTimeDomain and frequencyDomainAllocation define the CSI-RS location within a resource block (RB).
startingRB (only multiples of 4 are allowed) and nrofRBs (only multiples of 4 are allowed with a minimum value of 24) define the RB locations of CSI-RS in the frequency domain.

The specific CSI-RS resources for beam management, especially initial beam pairing, can be indicated via the Sidelink Control Information (SCI) transmitted by the UE 704. This indication can be carried in either the first stage SCI (SCI 1) or the second stage SCI (SCI 2), or both. The information may be the index or bit-string as described supra.

The UE 704 may transmit the SCI 1, which is carried in the PSCCH, using a wide beam in a broadcast manner to send the SCI 1 to the UE 706 and other nearby UEs. This allows the UE 706 to receive the SCI 1 even if the optimal beam pair between the UE 704 and the UE 706 has not been established yet.

On the other hand, the SCI 2, which is part of the PSSCH, can be transmitted using a different beam, such as a narrow beam. This allows the UE 704 to fine-tune the beam direction for the SCI 2 transmission based on the feedback from the UE 706 after the SCI 1 transmission.

This approach of using different beams for SCI 1 and SCI 2 transmission is different from the current sidelink design, where both SCI 1 and SCI 2 are transmitted using the same beam. By allowing different beams for SCI 1 and SCI 2, the beam management process can be more flexible and efficient.

In addition to indicating the CSI-RS resources, the SCI can also include an indicator to imply whether the current transmission is used for beam management purposes. This indicator can provide information such as:
The presence of beam management-related information in the current transmission.
The use of repetition or beam sweeping mode for the current transmission.
The Quasi-Co-Location (QCL) relationship between the current transmission and other transmissions or reference signals.

The beam management indicator can be a simple one-bit field or a more complex multi-bit field, depending on the amount of information to be conveyed. The interpretation of the indicator values can be predefined or configured by higher layers.

For example, the indicator can signal whether the current transmission is part of a beam sweeping process, where the UE 704 transmits the same information using different beams in a specific pattern. The indicator can also signal whether the current transmission is QCLed with a previous transmission or a reference signal, which helps the UE 706 in channel estimation and beam tracking.

The beam management indicator can be provided in the SCI format via a dedicated field or by reusing existing fields with predefined values. Alternatively, the indicator can be part of the CSI-RS configuration information that is either preconfigured or dynamically signaled.

The existing NR SL CSI framework only supports aperiodic CSI-RS transmission, which has to be transmitted together with data within the PSSCH. However, for effective beam management, including initial beam pairing (IBP) and beam maintenance, in SL FR2, a periodic or semi-persistent CSI-RS transmission is needed.

In certain configurations, the CSI-RS is (pre-) configured by the system to be transmitted periodically or semi-persistently. To support this, a new slot structure for standalone CSI-RS transmission and/or a new slot structure for CSI-RS transmission with data (i.e., CSI-RS within PSSCH) may be designed. The standalone CSI-RS transmission means that the CSI-RS is transmitted in a slot without any accompanying sidelink data (PSCCH). However, the slot may still contain SCI(s), SL MAC CE(s), or PSFCH.

In certain configurations, the CSI-RS transmission is dynamically indicated by the SCI. The CSI-RS configuration, such as the time-frequency resources, the beam, the periodicity, etc., is indicated by either the 1st stage SCI (i.e., SCI in PSCCH) or the 2nd stage SCI (i.e., SCI in PSSCH).

Furthermore, the new CSI-RS resource mapping configuration methods proposed in the previous sections, such as using an index or a bit-string to represent the CSI-RS resource mapping within a RB and across RBs, can be applied for both the periodic/semi-persistent CSI-RS and the dynamic CSI-RS.

As such, the UE 704 can transmit the CSI-RS using the configured resources, and the UE 706 can measure the CSI-RS to perform beam measurements for the IBP procedure.

In sidelink, there are two modes of operation for resource allocation and beam management: Mode 1 and Mode 2. In Mode 1, the gNB (e.g., the base station 702) is responsible for scheduling and resource allocation for the sidelink transmissions between UEs (e.g., the UE 704 and the UE 706). The gNB sends downlink control information (DCI) to the UEs, which includes the resource allocation for sidelink transmissions. In the context of beam management, the gNB can also configure and indicate the CSI-RS resources for beam management purposes in the DCI.

Specifically, the DCI can provide the CSI-RS resources in one or multiple symbols of the scheduled slots for sidelink transmission. The DCI can schedule resources for one or multiple slots. The UE receiving the DCI (e.g., the UE 704) can use the indicated CSI-RS resources for CSI-RS transmission on the sidelink (e.g., the sidelink 720). This CSI-RS transmission can be associated with PSCCH and/or PSSCH transmission, or it can be a standalone transmission without any associated PSCCH/PSSCH.

Furthermore, the gNB can schedule multiple UEs (e.g., the UE 704 and other UEs) for CSI-RS transmissions in a coordinated manner. The gNB can assign different time and/or frequency resources to different UEs for their CSI-RS transmissions, effectively implementing time division multiplexing (TDM) and/or frequency division multiplexing (FDM). This coordination helps to avoid collision and interference among the CSI-RS transmissions from different UEs.

To reduce the signaling overhead, the gNB can indicate the CSI-RS resources using an index. This index is associated with an entry in a preconfigured or pre-signaled table of CSI-RS resource configurations. The UE can use the received index to look up the corresponding CSI-RS resource configuration from the table and apply it for CSI-RS transmission.

In contrast to Mode 1, Mode 2 operation relies on the UEs to autonomously select and manage the resources for sidelink transmissions and beam management. In Mode 2, the UEs (e.g., the UE 704 and the UE 706) independently select the resources for sidelink communication from a preconfigured resource pool. They also perform beam sweeping and measurements autonomously to establish and maintain the beam pair for sidelink communication.

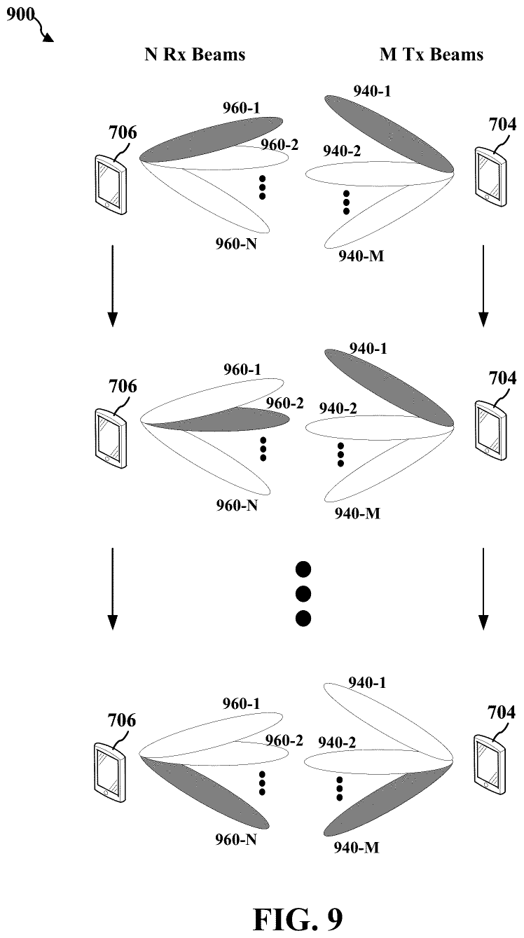

The capabilities of the UE 704 (Tx UE) need to be informed by the UE 704 to the UE 706 (Rx UE) and/or the capabilities of the UE 704 and the UE 706 need to be exchanged during and/or before initial beam pairing. The capabilities of the UE 704 and/or the UE 706 can cover many aspects, such as:
The number of coarse (wide) beams and/or fine (narrow) beams supported by the UE 704 and/or the UE 706. This information can help determine the total number of beam pairs that need to be tested during the initial beam pairing process. For example, if the UE 704 supports M transmission beams and the UE 706 supports N reception beams, then a total of M×N beam pairs need to be tested, as shown in FIG. 9 infra.
The number of panels of the UE 704 and/or the UE 706. Generally, different panels cannot be used simultaneously. Therefore, informing the number of panels can indicate the minimum number of time slots needed for beam sweeping. For instance, if the UE 704 has 4 panels and each panel supports 2 beams, then at least 4 time slots are needed for the UE 704 to complete the beam sweeping process.
The number of panels that can be enabled at the same time for transmitting and/or receiving for the UE 704 and/or the UE 706. If future UE designs support simultaneous transmission or reception across multiple panels, this capability information can indicate whether the UE can form an omnidirectional beam by enabling all panels simultaneously.

Furthermore, the total beam sweeping time and/or beam sweeping pattern/method of the UE 704 and/or the UE 706 can be determined based on the exchanged capability information. This can help optimize the initial beam pairing process and reduce the time and resources needed for beam sweeping.

The capability information can be exchanged in several ways. In certain configurations, the UE 704 (Tx UE) can inform the UE 706 (Rx UE) of its capabilities. In certain configurations, the UE 704 and the UE 706 can mutually exchange their capabilities.

The exchange of capability information can occur at different times during the initial beam pairing process. For example, the capability information can be included in the discovery messages or feedback messages exchanged between the UE 704 and the UE 706 on the sidelink 720. The exchange of capability information can occur before the initial beam pairing process. For example, the capability information can be pre-configured in the UE 704 and the UE 706, or can be provided by the base station 702.

FIG. 9 is a diagram 900 illustrating a beam burst pattern. In this example, the UE 704 forms M transmission beams 940-1, 940-2, . . . , 940-M. The UE 706 forms N reception beams 960-1, 960-2, . . . , 960-N. The UE 704 may transmit using its first beam (e.g., 940-1) for N times, while the UE 706 performs beam sweeping with its N reception beams. Then, the UE 704 switches to its second beam (e.g., 940-2) and transmits for another N times, while the UE 706 again performs beam sweeping with its N reception beams. This process continues until all M×N transmissions and measurements are completed.

The UE 704 may have a gap when switching from one transmission beam to another. However, the entire M×N process is still considered as one beam burst, as the complete beam sweeping is beneficial to obtain reliable IBP results.

To receive and/or decode discovery messages, one or more bursts may be used for IBP. If more than one burst is used, the first burst can be used for receiving and decoding the discovery message 1 or the first stage SCI, while the second burst can be used for receiving and decoding the discovery message 2 or the second stage SCI.

The beam burst, consisting of M×N beam transmissions, is considered a unit for resource allocation and alignment in the resource pool. The entire IBP procedure is completed within the allocated resources, enabling the UE 704 and the UE 706 to establish the optimal beam pair for communication on the sidelink 720.

Further, the UE 704 and the UE 706 can adopt several beam burst pattern options or beam sweeping modes for initial beam pairing (IBP) on the sidelink 720. These options can be (pre-) configured and/or indicated, and can be applied separately for the UE 704 as the transmitter UE and the UE 706 as the receiver UE. In one option, a UE sweeps its beams in a simple sequential cycle. In another option, the beam sweeping of a UE is repeated for each beam for a certain number of times. In yet another option, the beam sweeping pattern of a UE follows a cyclic shift.

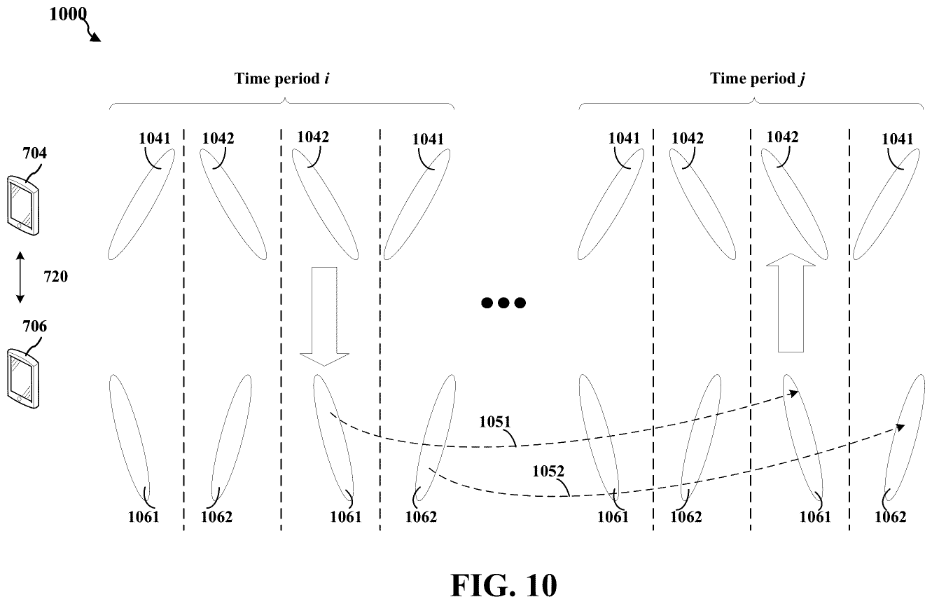

FIG. 10 is a diagram 1000 illustrating a beam reporting. In this example, the UE 704 forms two beams 1041 and 1042. The UE 706 forms two beams 1061 and 1062. The UE 704 and the UE 706 each select a particular beam sweeping patter for IBP. For example, in a time period i, which contains 4 time units (e.g., 4 slots or 4 OFDM symbols), the UE 704 transmits RSs using the beam 1041, the beam 1042, the beam 1042, the beam 1041 sequentially. One beam is used in one time unit. In the time unit i, the UE 706 receives the RSs using the beam 1061, the beam 1062, the beam 1061, the beam 1062 sequentially. One beam is used in one time unit.

Subsequently, in a time period j, which contains 4 time units (e.g., 4 slots or 4 OFDM symbols), the UE 706 transmits data, if any, to the UE 704 using the beam 1061, the beam 1062, the beam 1061, the beam 1062 sequentially. One beam is used in one time unit. In the time unit j, the UE 704 receives data using the beam 1041, the beam 1042, the beam 1042, the beam 1041 sequentially. One beam is used in one time unit.

In sidelink, a Physical Sidelink Feedback Channel (PSFCH) is a physical channel used for transmitting feedback information from a receiver UE to a transmitter UE. The PSFCH is primarily designed for carrying Hybrid Automatic Repeat Request (HARQ) feedback, indicating whether a transmission was successfully decoded or not.

However, in the context of beam management for sidelink in FR2, the PSFCH can be extended to carry beam reporting information. A beam report, generated by the UE 706 after measuring the reference signals (RSs) transmitted by the UE 704, can be transmitted back to the UE 704 using the PSFCH. For example, additional bits can be allocated to carry the beam quality metrics, or a new PSFCH format can be defined specifically for beam reporting purposes.

Furthermore, the PSFCH resources for beam reporting may be configured separately from the PSFCH resources for HARQ feedback, to avoid potential conflicts and to allow for more flexible resource allocation.

The beam report carried by the PSFCH can include various beam quality metrics, such as the Channel State Information Reference Signal Received Power (CSI-RS RSRP) and/or the Demodulation Reference Signal Received Power (DMRS RSRP). These metrics help the UE 704 to assess the quality of its transmitted beams and to select the optimal beam for communication with the UE 706.

The PSFCH carrying the beam report is transmitted at a corresponding time occasion and/or a corresponding resource location. This means that the time and frequency resources used for the PSFCH transmission are associated with the time and frequency resources of the RS that the beam report is based on.

More specifically, as shown, the UE 704 transmits reference signals (RSs) using the beam 1041 and the beam 1042 in different directions. The UE 706 monitors beam qualities by measuring these RSs. The UE 706 may transmit a beam report indicating the beam qualities via a PSFCH to the UE 704. The beam qualities measured by the UE 706 may be obtained by CSI-RS RSRP and/or DMRS RSRP. The beam report may be carried by a PSFCH at a corresponding time occasion and/or a corresponding resource location.

In the time period i, the UE 704 transmits RSs using the beam 1041 and the beam 1042 in a specific pattern. The UE 706 receives these RSs using the beam 1061 and the beam 1062 in a corresponding pattern. The UE 706 measures the beam qualities of the received RSs.

Subsequently, in the time period j, the UE 706 transmits the PSFCH feedback using the beam 1061 and the beam 1062. The beam used for each PSFCH feedback transmission corresponds to the beam used for receiving the RS in the time period i. For example, if the UE 706 received an RS using the beam 1061 in the first time unit of the time period i, it will transmit the corresponding PSFCH feedback using the beam 1061 in the first time unit of the time period j.

The PSFCH feedback carries the beam report indicating the beam quality measurements for the RSs received in the time period i. The time occasion and/or resource location of each PSFCH feedback corresponds to the time occasion and/or resource location of the RS it is measuring. This allows the UE 704 to associate each PSFCH feedback with the specific beam it used for RS transmission.

In certain configurations, the beam report of a beam pair may be transmitted at a subsequent, corresponding time occasion and/or a corresponding resource location of the same beam pair. For example, the UE 706 generates a beam report 1051 for using the beam 1061 to receive the beam 1042 transmitted by the UE 704. The UE 706 may subsequently, in the time period j, transmit the beam report 1051 in a PSFCH using the beam 1061, which is received by the UE 704 using the beam 1042. Similarly, the UE 706 transmits a beam report 1052, which is associated with the beam 1041 and the beam 1062 in the time period i, in a PSFCH using the beam 1062, which is received by the UE 704 using the beam 1041.

For the UE 706 (Rx UE), if the measured RSRP quality is higher than a (pre-) configured threshold and/or good enough for reception (e.g., the associated data is decodable), the PSFCH indicating the corresponding beam quality is transmitted based on the timing with the following two options.

In Option 1, the PSFCH is transmitted based on the ACK/NACK feedback timing of the existing PSFCH mechanism in NR SL. One, two, or a set of candidate PSFCH resources for the corresponding beam measurement result and/or quality indication are corresponding to each CSI-RS resource transmitted from the UE 704 (Tx UE).

The different candidate PSFCH resources may indicate:
Whether the corresponding CSI-RS transmission from the UE 704 is good enough (e.g., higher than a (pre-) configured threshold, satisfying a (pre-) configured criteria, etc.).
Different measured result values and/or measured result qualities of the corresponding CSI-RS measurement results (e.g., absolute RSRP value, OK/Good/Excellent quality, etc.). The mapping rules between the PSFCH resources and the quantity values could be (pre-) configured.
Whether the measured result/quality of the corresponding CSI-RS transmission is better than the early reported one.

For example, as shown in FIG. 10, the UE 704 has different transmission beams represented by the beam 1041 and the beam 1042. The UE 706, as the Rx UE, receives the corresponding reference signals and performs beam reporting on the corresponding beams.

If the measured RSRP for the corresponding CSI-RS transmission is higher than a (pre-) configured threshold and/or higher than any early measured RSRP and/or any early reported RSRP corresponding to the previous CSI-RS transmissions, the UE 706 can transmit PSFCH to indicate that the corresponding CSI-RS transmission is a suitable one. Otherwise, there is no PSFCH transmission for reporting.

These beam reporting mechanisms related to Option 1 are not limited to initial beam pairing (IBP) but are also applicable to beam maintenance (BM) and beam failure recovery (BFR).

The beam report and the existing ACK/NACK feedback can be transmitted together using the PSFCH. One approach is to allocate different PSFCH resources for beam reporting and ACK/NACK feedback. For example, a subset of PSFCH resources can be reserved for beam reporting, while the remaining resources are used for ACK/NACK feedback. The allocation of PSFCH resources for different purposes can be (pre-) configured or dynamically indicated.

Alternatively, the beam report and ACK/NACK feedback can be multiplexed or jointly coded within the same PSFCH resource. In this case, additional bits can be added to the PSFCH payload to carry the beam report information along with the ACK/NACK feedback. The multiplexing or joint coding scheme can be (pre-) configured or specified in the standard.

In Option 2, the timing for the PSFCH indicating beam quality is (pre-) configured and separate from the ACK/NACK feedback. This means that a new PSFCH is used for beam reporting, with its timing configured independently from the existing PSFCH used for ACK/NACK feedback.

In certain configurations, the UE 706 may only reserve one PSFCH time resource for the feedback. The PSFCH time resource may correspond to multiple CSI-RS resource measurements. The PSFCH may only indicate which beam is the best among the measured beams.

For example, the UE 704 transmits on CSI-RS resources using the beam 1041, the beam 1042 in the time period i. The UE 706 measures the quality of these beams using the beam 1061 and the beam 1062. Instead of sending a PSFCH for each measured beam, the UE 706 only sends one PSFCH in the time period j to indicate which beam among the beam 1041, the beam 1042 is the best.

The PSFCH resources for beam reporting are (pre-) configured separately from the PSFCH resources for ACK/NACK feedback to avoid conflicts and allow for more flexible resource allocation. The PSFCH resources for beam reporting can be determined based on the source ID and/or destination ID of the UEs. For example, the PSFCH resource index i can be calculated as the source and/or destination IDs modulo the total number of PSFCH resources reserved for beam reporting.

The PSFCH indicating the best beam can either be transmitted on the activated beam or by resource selection. The activated beam refers to the beam pair that is currently being used for data transmission between the UE 704 and the UE 706. If the PSFCH is transmitted on the activated beam, it means that the UE 706 uses the same beam (e.g., the beam 1062) to transmit the PSFCH as it uses to receive data from the UE 704.

On the other hand, if the PSFCH is transmitted by resource selection, it means that the UE 706 selects a different beam (e.g., the beam 1061) to transmit the PSFCH than the activated beam. The selection of the beam for PSFCH transmission can be based on various factors, such as the beam quality, the interference level, or the available resources.

Resource selection refers to the process of selecting the time, frequency, and/or beam resources for PSFCH transmission. This process can be based on a predefined rule or a dynamic selection algorithm. For example, the UE 706 can select the beam with the best quality among its receiving beams (e.g., the beam 1061 and the beam 1062) to transmit the PSFCH. Alternatively, the UE 706 can select the beam that has the least interference or the most available resources for PSFCH transmission.

The decision of whether to use the activated beam or resource selection for PSFCH transmission can be (pre-) configured by the network or based on a predefined rule. For example, the network can configure the UE 706 to always use the activated beam for PSFCH transmission. Alternatively, the UE 706 can be configured to use resource selection for PSFCH transmission if the activated beam's quality falls below a certain threshold.

In certain scenarios, the UE 706 (Rx UE) may need to measure and report the beam quality for beams other than the currently activated beam. Using the example shown in FIG. 10, after the IBP, the UE 704 (Tx UE) and the UE 706 have established a beam pair using the beam 1042 and the beam 1061 for communication on the sidelink 720. This beam pair is considered as the activated beam pair.

However, the UE 706 may also measure the quality of other beams, such as the beam 1041, which is not part of the activated beam pair. In this case, the UE 706 needs to report the measurement results of the beam 1041 to the UE 704 to facilitate beam management procedures.

There are two options for the UE 706 to report the measurement results of non-activated beams:
Reporting on the activated beam via PSFCH: In this option, the UE 706 transmits the beam report for the non-activated beam (e.g., the beam 1041) using the PSFCH resources associated with the activated beam (e.g., the beam 1061). This approach does not require any extra resource selection procedure, as the PSFCH resources for the activated beam are already established.
Reporting on the activated beam via PSSCH: In this option, the UE 706 transmits the beam report for the non-activated beam using the PSSCH associated with the activated beam. The beam report can be carried in the 2nd stage SCI or as part of the data payload in the PSSCH. However, this approach requires a resource selection procedure to determine the appropriate PSSCH resources for the beam report transmission.

The choice between these two options can be based on various factors, such as the current mode of operation (e.g., connected mode or idle mode), the available resources, or the desired level of reliability for the beam report transmission.

By enabling the UE 706 to report the measurement results of non-activated beams, the proposed techniques enhance the beam management capabilities in NR sidelink communications, particularly in scenarios where the quality of the activated beam degrades, and alternative beams need to be considered for maintaining the link quality or recovering from beam failures.

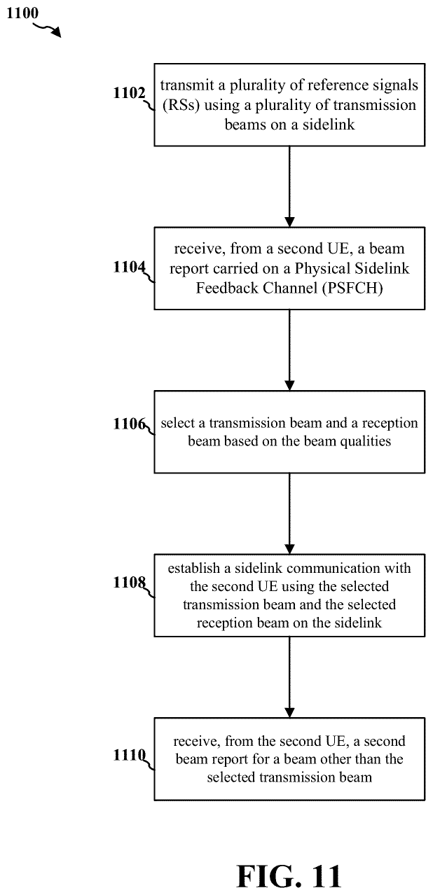

FIG. 11 is a flow chart 1100 of a method (process) for establishing a sidelink communication between user equipments (UEs). The method may be performed by a first UE (e.g., the UE 704). In operation 1102, the first UE transmits a plurality of reference signals (RSs) using a plurality of transmission beams on a sidelink. In operation 1104, the first UE receives, from a second UE, a beam report carried on a Physical Sidelink Feedback Channel (PSFCH). The beam report indicates beam qualities generated by the second UE based on measurements of the plurality of RSs. In operation 1106, the first UE selects a transmission beam and a reception beam based on the beam qualities. In operation 1108, the first UE establishes a sidelink communication with the second UE using the selected transmission beam and the selected reception beam on the sidelink.

In certain configurations, the beam report is received on the PSFCH at a corresponding time occasion or a corresponding resource location associated with the selected transmission beam.

In certain configurations, the PSFCH carrying the beam report is received based on a timing of receiving a PSFCH for Acknowledgement/Negative Acknowledgement (ACK/NACK) feedback. Different candidate PSFCH resources may indicate whether a signal quality of a corresponding RS, transmitted from the first UE and received at the second UE, meets a criterion. Different candidate PSFCH resources may indicate different measured result values or measured result qualities of a corresponding RS transmitted from the first UE and received at the second UE. Different candidate PSFCH resources may indicate whether a measured result or quality of a corresponding RS, transmitted from the first UE and received at the second UE, is better than that of a previously reported RS.

In certain configurations, a timing for the PSFCH carrying the beam report is separate from a timing for receiving a PSFCH for ACK/NACK feedback. One PSFCH time resource may be reserved for the beam report, the one PSFCH time resource corresponding to one or more RSs and indicating a suitable RS among the one or more RSs.

In certain configurations, a PSFCH resource for the beam report is determined according to at least one of a source ID and a destination ID of the first UE and the second UE.

In certain configurations, the PSFCH carrying the beam report is transmitted on an activated beam. In certain configurations, the PSFCH carrying the beam report is transmitted on a beam determined based on a resource selection procedure.

In operation 1110, the first UE receives, from the second UE, a second beam report for a beam other than the selected transmission beam. The second beam report may be received on the selected transmission beam via the PSFCH without requiring an extra resource selection procedure. The second beam report may be received on an activated beam via a PSFCH. The second beam report may be received on an activated beam via a Physical Sidelink Shared Channel (PSSCH) using a resource selection procedure. The second beam report may be carried in a 2nd stage Sidelink Control Information (SCI) of the PSSCH. The second beam report may be carried in a data payload of the PSSCH.

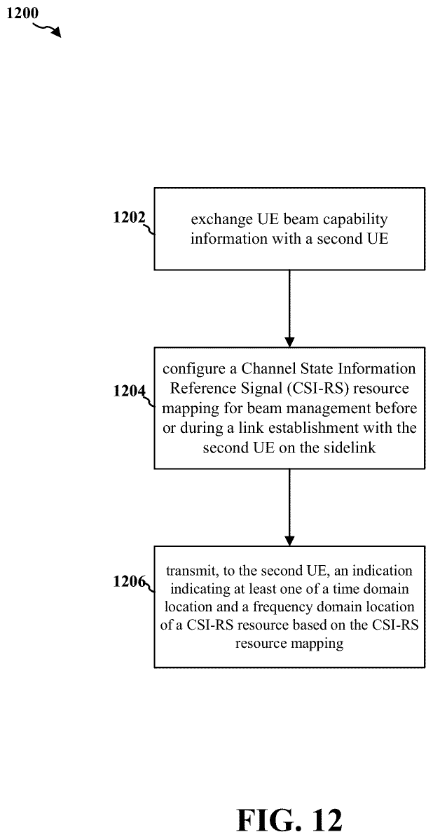

FIG. 12 is a flow chart 1200 of a method (process) for beam management on a sidelink. The method may be performed by a first UE (e.g., the UE 704). In operation 1202, the first UE exchanges UE beam capability information with a second UE (e.g., the UE 706) before or during an initial beam pairing procedure on a sidelink (e.g., the sidelink 720). The UE beam capability information includes at least one of a number of beams supported by the first UE, a number of panels of the first UE, or a number of panels that can be enabled simultaneously for transmitting or receiving by the first UE. In operation 1204, the first UE configures a Channel State Information Reference Signal (CSI-RS) resource mapping for beam management before or during a link establishment with the second UE on the sidelink. In operation 1206, the first UE transmits, to the second UE, an indication indicating at least one of a time domain location and a frequency domain location of a CSI-RS resource based on the CSI-RS resource mapping.

In certain configurations, the indication comprises an index or a bit-string representing a combination of at least one of a time location of CSI-RS resource elements (REs) within a resource block (RB), a frequency location of CSI-RS REs within the RB, a starting RB, and an RB quantity in a frequency domain.

In certain configurations, the indication is transmitted via at least one of a first Sidelink Control Information (SCI) and a second SCI. The first SCI is broadcast in a wide beam and the second SCI is transmitted in a unicast beam narrower than the wide beam.

In certain configurations, the first SCI or the second SCI comprises an indicator indicating whether a current transmission is used for beam management with at least one of a repetition or a beam-sweeping mode, or whether beams are Quasi-Co-Located (QCLed). The indicator is provided by a pre-configuration or indicated in the first SCI or the second SCI.

In certain configurations, the indication indicates a periodic CSI-RS configuration. In certain configurations, the indication indicates an aperiodic CSI-RS configuration, and the CSI-RS configuration is carried by a first stage SCI or a second stage SCI.

In certain configurations, the first UE receives, from a base station (e.g., the base station 702), a Downlink Control Information (DCI) scheduling a sidelink transmission. The DCI indicates CSI-RS resources for beam management in one or more symbols of one or more slots scheduled for the sidelink transmission. The first UE uses the indicated CSI-RS resources for CSI-RS transmission.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a first user equipment (UE), comprising:
transmitting a plurality of reference signals (RSs) using a plurality of transmission beams on a sidelink;
receiving, from a second UE, a beam report carried on a Physical Sidelink Feedback Channel (PSFCH), the beam report indicating beam qualities generated by the second UE based on measurements of the plurality of RSs;
selecting a transmission beam and a reception beam based on the beam qualities; and
establishing a sidelink communication with the second UE using the selected transmission beam and the selected reception beam on the sidelink.

2. The method of claim 1, wherein the beam report is received on the PSFCH at a corresponding time occasion or a corresponding resource location associated with the selected transmission beam.

3. The method of claim 1, wherein the PSFCH carrying the beam report is received based on a timing of receiving a PSFCH for Acknowledgement/Negative Acknowledgement (ACK/NACK) feedback.

4. The method of claim 3, wherein different candidate PSFCH resources indicate whether a signal quality of a corresponding RS, transmitted from the first UE and received at the second UE, meets a criterion, or indicate different measured result values or measured result qualities of a corresponding RS transmitted from the first UE and received at the second UE, or indicate whether a measured result or quality of a corresponding RS, transmitted from the first UE and received at the second UE, is better than that of a previously reported RS.

5. The method of claim 1, wherein a timing for the PSFCH carrying the beam report is separate from a timing for receiving a PSFCH for Acknowledgement/Negative Acknowledgement (ACK/NACK) feedback.

6. The method of claim 5, wherein one PSFCH time resource is reserved for the beam report, the one PSFCH time resource corresponding to one or more RSs and indicating a suitable RS among the one or more RSs.

7. The method of claim 1, wherein a PSFCH resource for the beam report is determined according to at least one of a source ID and a destination ID of the first UE and the second UE.

8. The method of claim 1, wherein the PSFCH carrying the beam report is transmitted on an activated beam, or on a beam determined based on a resource selection procedure.

9. The method of claim 1, further comprising:
receiving, from the second UE, a second beam report for a beam other than the selected transmission beam.

10. The method of claim 1, wherein the second beam report is received on the selected transmission beam via the PSFCH without requiring an extra resource selection procedure.

11. The method of claim 10, wherein the second beam report is received on an activated beam via a PSFCH.

12. The method of claim 10, wherein the second beam report is received on an activated beam via a Physical Sidelink Shared Channel (PSSCH) using a resource selection procedure.

13. The method of claim 10, wherein the second beam report is carried in a 2nd stage Sidelink Control Information (SCI) of the PSSCH, or in a data payload of the PSSCH.

14. A method of wireless communication by a first user equipment (UE), comprising:
configuring a Channel State Information Reference Signal (CSI-RS) resource mapping for beam management before or during link establishment with a second UE on a sidelink; and
transmitting, to the second UE, an indication indicating at least one of a time domain location and a frequency domain location of a CSI-RS resource based on the CSI-RS resource mapping.

15. The method of claim 14, wherein the indication comprises an index or a bit-string representing a combination of at least one of a time location of CSI-RS resource elements (REs) within a resource block (RB), a frequency location of CSI-RS REs within the RB, a starting RB, and an RB quantity in a frequency domain.

16. The method of claim 14, wherein the indication is transmitted via at least one of a first Sidelink Control Information (SCI) and a second SCI, wherein the first SCI is broadcast in a wide beam and the second SCI is transmitted in a unicast beam narrower than the wide beam, wherein the first SCI or the second SCI comprises an indicator indicating whether a current transmission is used for beam management with at least one of a repetition or a beam-sweeping mode, or whether beams are Quasi-Co-Located (QCLed).

17. The method of claim 14, wherein the indication indicates a periodic CSI-RS configuration, or the indication indicates an aperiodic CSI-RS configuration, and wherein the indication CSI-RS configuration is carried by a first stage SCI or a second stage SCI.

18. The method of claim 14, further comprising:
receiving, from a base station, a Downlink Control Information (DCI) scheduling a sidelink transmission, wherein the DCI indicates CSI-RS resources for beam management in one or more symbols of one or more slots scheduled for the sidelink transmission; and
using the indicated CSI-RS resources for CSI-RS transmission.

19. The method of claim 14, further comprising:
exchanging UE beam capability information with the second UE before or during an initial beam pairing procedure, wherein the UE beam capability information comprises at least one of a number of beams supported by the first UE, a number of panels of the first UE, or a number of panels that can be enabled simultaneously for transmitting or receiving by the first UE.

20. An apparatus for wireless communication, the apparatus being a first user equipment (UE), comprising:
a memory; and
at least one processor coupled to the memory and configured to:
transmit a plurality of reference signals (RSs) using a plurality of transmission beams on a sidelink;
receive, from a second UE, a beam report carried on a Physical Sidelink Feedback Channel (PSFCH), the beam report indicating beam qualities generated by the second UE based on measurements of the plurality of RSs;
select a transmission beam and a reception beam based on the beam qualities; and
establish a sidelink communication with the second UE using the selected transmission beam and the selected reception beam on the sidelink.
